(19) United States
(12) Patent Application Publication
(10) Pub. No.: US 2014/0125642 A1
(43) Pub. Date: May 8, 2014

(54) Display System Ocular Imaging

(71) Applicant: BROADCOM CORPORATION, Irvine, CA (US)

(72) Inventors: Larry Pearlstein, Newton, PA (US); Michael Erwin, Columbus, NJ (US)

(73) Assignee: Broadcom Corporation, Irvine, CA (US)

(21) Appl. No.: 13/669,080

(22) Filed: Nov. 5, 2012

(51) Int. Cl. G06F 3/038

(52) U.S. Cl. 345/207

(57) ABSTRACT

A device includes ocular image processing features. The device obtains ocular image data without requiring artificial lenses to capture the ocular image data. The device may, for example, obtain sensor data from a touch sensor associated with a display, recognize ocular image data within the sensor data, and process the ocular image data for any reason. This processing may occur regardless of the fact that the intended purpose of the sensor data was not for ocular imaging, but was intended for another purpose, such as detecting touch interactions with the display.

### TECHNICAL FIELD

This disclosure relates to ocular (e.g., retinal) imaging. This disclosure also relates to ocular imaging using display systems that include associated sensors such as photodiodes.

### BACKGROUND

Rapid advances in electronics and communication technologies, driven by immense customer demand, have resulted in the widespread adoption of computing and communication devices, such as smart phones, desktop computers, and electronic book readers. One common element of these devices is a display, such as a Liquid Crystal flat panel display, and a touch sensing system for interacting with the information on the display. Extensions to device functionality to provide additional device capabilities will help continue to make such devices attractive to the consumer.

### BRIEF DESCRIPTION OF THE DRAWINGS

The innovation may be better understood with reference to the following drawings and description. In the figures, like reference numerals designate corresponding parts throughout the different views.

FIG. 1 shows an example ocular imaging system.

FIG. 2 figure shows a device that obtains and processes ocular image data.

FIGS. 3-5 show examples of logic that a device that obtains and processes ocular image data may implement.

### DETAILED DESCRIPTION

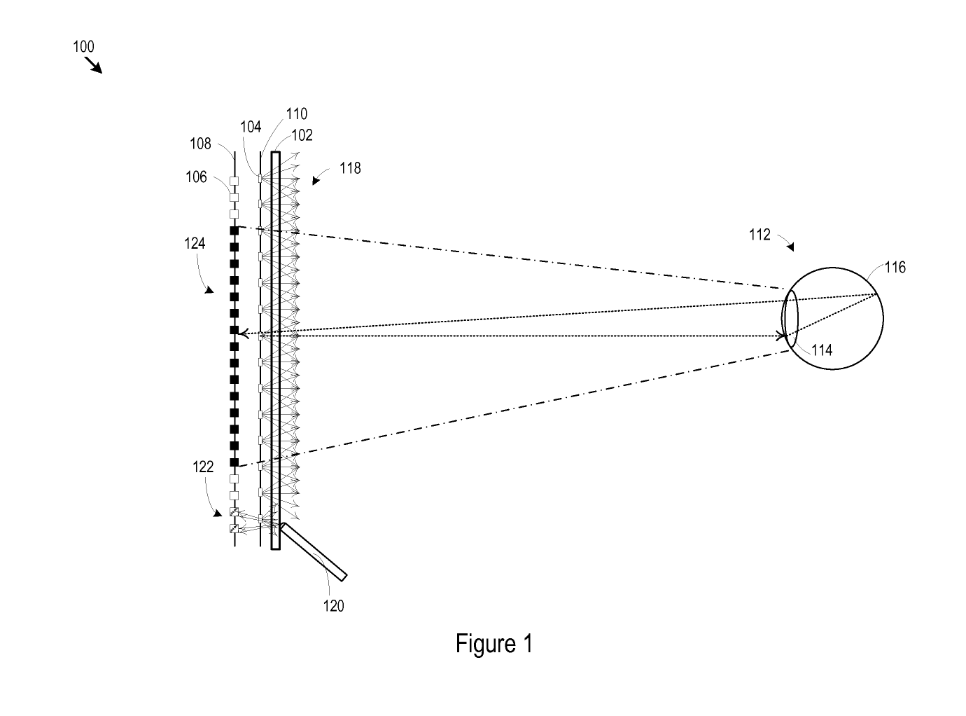

FIG. 1 shows an example of an ocular imaging system 100. The system 100 may be incorporated into virtually any device, including as a few examples, smart phones, televisions, point of sale kiosks, and computers (e.g., a desktop, laptop, or tablet computer). The system 100 includes a display 102, illuminators 104, and sensors 106. The sensors 106 may be arranged on a sensor plane 108 positioned, for example, behind an illuminator plane 110 of the illuminators 104.

The system 100 may be a subsystem of a larger device, such as a smart phone. As one example, a manufacturer may manufacture the system 100 as an assembly that includes the display 102, sensor plane 108 and illuminator plane 110. However, a manufacturer may build the sensors plane 108 and illuminator plane 110 as a separate assembly as well, to which another manufacturer may add the display 102, or add to a larger device including a display 102 and logic that implements device functionality.

The display 102 may be a liquid crystal display (LCD), organic light emitting diode (OLED) display, or other type of electronic display. A display controller may drive the display 102 to generate the images perceived by the operator. However, the techniques described below are not necessarily limited to electronic displays, as the sensors 106 and illuminators 104 may be used in association with virtually any type of information display has transparency to the energy from the illuminators 104 that is sufficient for the sensors 106 to detect.

The illuminators 104 may be in place to fulfill an originally intended primary function, such as touch screen operation for the device. In that regard, the illuminators 104 may be infrared illuminators, and the sensors 106 may be infrared photodiodes. The illuminator plane 110 may be an infrared backlight, for example. In other implementations, the illuminators 104 and their sensors 106 generate and receive energy of wavelengths other than infrared. For instance, the illuminators 104 may be light emitting diodes (LED) for an LED backlight for the display 102, and the sensors 106 may be responsive to whatever range of wavelengths are emitted by the LEDs.

A touchscreen controller may drive the illuminators 104 and read sensor data from the sensors 106. In operation, the controller drives the illuminators 104 so that they generate energy 118. In the context of touchscreen operation, an object 120 reflects some of the energy 118 back through the display 102 to the sensors 106. The object 120 may be a finger, stylus, or other object. The touchscreen controller may then read sensor data 122 from the sensors 106 and determine, as examples, which parts of the display 102 are receiving touches, relative motion of the object 120, and other touch interactions.

Naturally, while the operator is interacting with the device, the operator's eyes are often focused on the display 102. In the eye 112, the lens 114 projects and focuses the retina 116 and cornea across the display 102. No artificial intermediate lens is needed to do so, because the natural lens 114 performs the focusing. Thus, within the sensor data is often ocular image data 124 (including, as examples, image data for the retina, cornea, macula, fovea, blood vessels, and other physical features of the eye), and, moreover, ocular image data 124 naturally in-focus due to the natural operation of the lens 114 of the eye 112.

Some introductory implementation examples are now given, before continuing on to additional detailed description. The techniques described below include reading sensor data from the sensors 106 associated with the display 102. A device extracts, recognizes, or otherwise obtains ocular image data (e.g., retinal image data) from the sensor data, and processes the ocular image data. The processing may include, as just two examples, biometric identification of the operator, and location tracking of the gaze of the operator across the display 102. As another example, a device may include as part of its implementation logic, a display controller operable to drive the display 102, sensor inputs for the sensors 106 associated with the display 102, and processing logic that receives the sensor inputs. The processing logic is operable to read sensor data from the sensor inputs, obtain biometric data from the sensor data, and process the biometric data. As noted above, no lens external to the eye is needed to do so. Accordingly, as another example, a device may include a display and a sensor plane behind the display. The sensor plane receives energy focused by the lens 114 of the eye 112 that is viewing the display, instead of by an intermediate lens outside of the eye 112. The device further includes processing logic in communication with the sensor plane. The processing logic is operable to read sensor data arising from the energy received by the sensor plane, and operate on ocular image data (e.g., retinal image data) obtained from the sensor data.

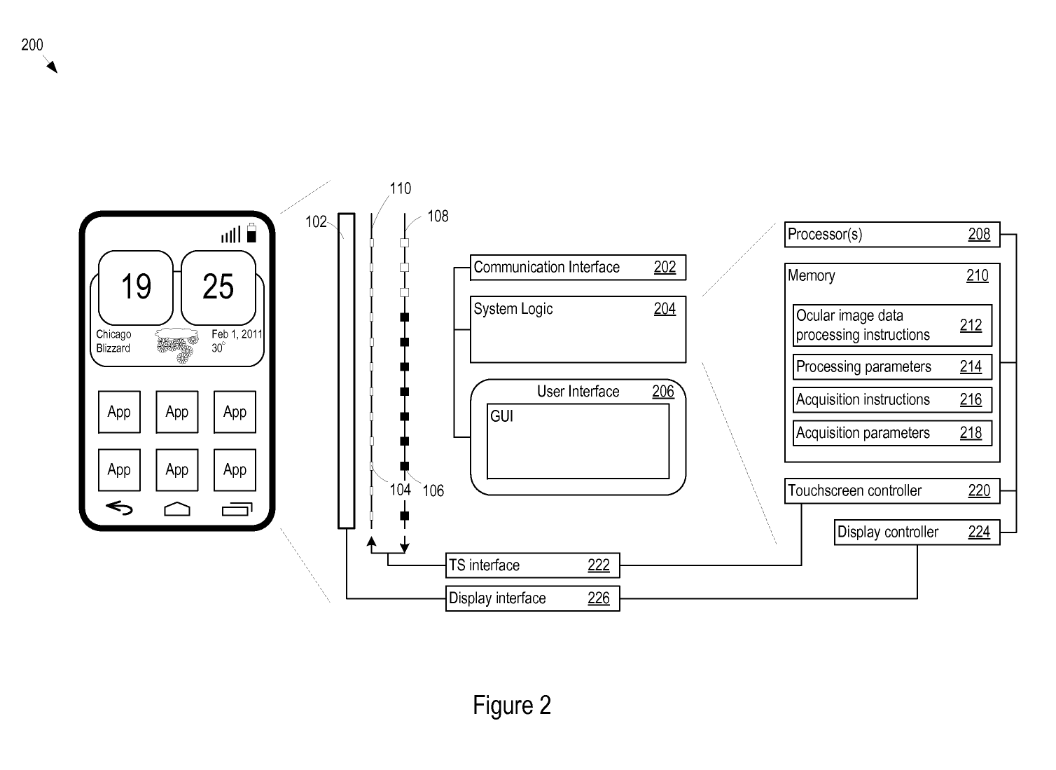

Turning to FIG. 2, that figure shows an example of a device 200 that receives and processes ocular image data. The device 200 in this example is a smart phone, but the device 200 could be any other computing device with a visual interface. The device 200 includes the display 102, illuminator plane 110, and the sensor plane 108. In the example shown in FIG. 2, the device 200 includes a communication interface 202 and system logic 204, and generates a user interface 206 that may appear on the display 102.

The system logic 204 may include any combination of hardware, software, firmware, or other logic. The system logic 204 may be implemented, for example, in one or more systems on a chip (SoC), application specific integrated circuits (ASIC), or other circuitry. The system logic 204 is part of the implementation of any desired functionality in the device 200. In that regard, the system logic 204 may include logic that facilitates, as just a few examples, running applications; accepting user inputs; saving and retrieving application data; establishing, maintaining, and terminating cellular phone calls, wireless network connections, Bluetooth connections, or other connections; and displaying relevant information on the user interface 206. The user interface 206 may include a graphical user interface, touch sensitive display, voice or facial recognition inputs, buttons, switches, and other user interface elements.

The communication interface 202 may include one or more transceivers. The transceivers may be wireless transceivers that include modulation/demodulation circuitry, amplifiers, analog to digital and digital to analog converters and/or other logic for transmitting and receiving through one or more antennas, or through a physical (e.g., wireline) medium. The transmitted and received signals may adhere to any of a diverse array of formats, protocols, modulations, frequency channels, bit rates, and encodings.

In one implementation, the system logic 204 includes one or more processors 208 and memories 210. The memory 210 may store, for example, retinal image processing instructions 212 that the processor 208 executes under direction of the processing parameters 214. The memory 210 may also store acquisition instructions 216 that the processor 208 executes under direction of the acquisition parameters 218. As will be described in more detail below, the retinal image processing instructions 212 and acquisition instructions 216 facilitate obtaining, recognizing, and processing ocular image data obtained from the sensors 106.

The sensors 106 may be associated with the display 102 in the sense that, as just one example, they are sensors for a touchscreen interface to the display 102. In that regard, the device 200 may also include a touchscreen controller 220 and a touchscreen interface 222 to the sensor plane 108. The touchscreen interface 222 may include the buffers, amplifiers, illuminator and sensor control lines, and other interface circuitry for driving the illuminators 104 and reading the sensors 106 under control of the touchscreen controller 220. Similarly, the display interface 226 may include the buffers, amplifiers, pixel clocks, pixel control lines, and other interface circuitry for causing the display 102 to generate images under direction of the display controller 224.

Although the discussion below refers to ocular image data, the sensors 106 may receive, and the system logic 204 may recognize and process, different types of biometric data. Other examples of biometric data include fingerprint data and handprint data. One aspect of the device 200 is that the biometric data is obtained from sensors that were not necessarily added to the device to obtain biometric data. In connection with a touchscreen for the display 102, for example, the illuminators 104 and sensors 106 may have been intended to identify and track touch interactions with the display 102. Nevertheless, the system logic 204 may extract ocular image data from the data read from the sensors 106, with the knowledge that the eye 112 may often focus retinal patterns onto the display 102 in the normal course of operator interaction with the device. The ocular image data may be particularly strong when infra-red illuminators are used for the touchscreen operation, due to the high reflectivity of infra-red energy by the retina.

The device 200 may, at any desired interval, obtain sensor data, recognize, obtain, or extract ocular image data from the sensor data, and process the ocular image data. As examples, the device 200 may determine to obtain ocular image data on a periodic, non-periodic, random, or operator specified basis. As another example, the device 200 may obtain ocular image data when instructed by an application running on the device 200. These acquisition preferences may be stored as part of the acquisition parameters 218, for example.

In the normal operation of the device 200, the illuminators 104 may be regularly activating, and the sensors 106 regularly providing sensor data to, for example, the touchscreen controller 220. Accordingly, the device 200 may have a regular supply of sensor data from which to obtain ocular image data for processing by the ocular image data processing instructions 212.

The processing instructions 212 may include any application, firmware, or other code on the device 200 that accomplishes any ocular imaging purpose. The processing parameters 214 guide the operation of the processing instructions 212. To that end, just as a few examples, the processing parameters 214 may: specify which biometric (e.g., retinal, fingerprint, or handprint) features to search for, in the context of biometric identification; provide a database of biometric (e.g., retinal, fingerprint, or handprint) image data or other feature characteristic data for the processing instructions 212 to match against; specify which body part (e.g., which eye, finger, or hand) to use for the biometric identification; specify how often to verify biometric identity; specify what happens when identification is successful or not successful; and any other operating parameters for the processing instructions 212.

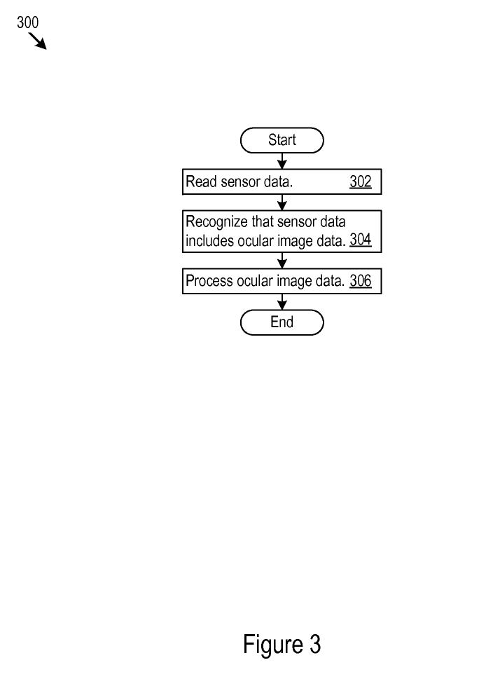

FIG. 3 shows an example of logic 300 that the device 200 may implement, e.g., as part of the processing instructions 212. The logic 300 reads the sensor data from the sensors 106 (302). The logic 300 then recognizes, extracts, or otherwise obtains ocular image data from the sensor data (304). The logic 300 need not extract the ocular image data in the sense that the logic 300 creates physically separate data. Instead, the logic 300 may perform processing operations on the sensor data that make sense, recognizing that ocular image data exists in the sensor data. Given the ocular image data, the logic 300 processes the ocular image data (306) to perform biometric identification, view tracking, facilitate medical diagnosis of the eye, or for any other reason.

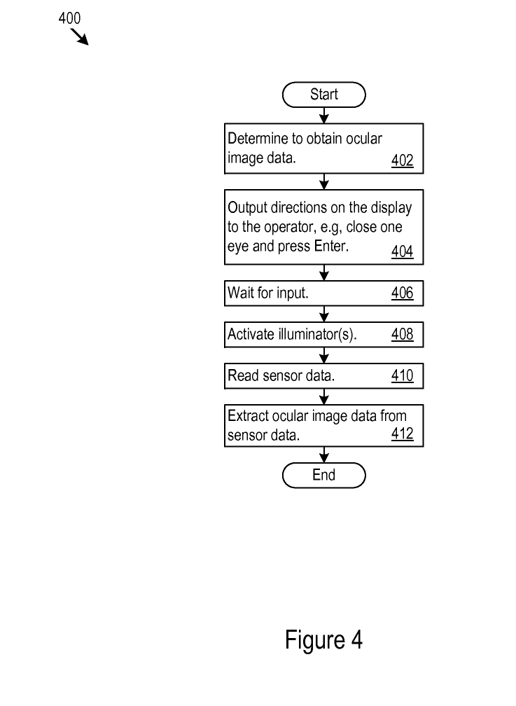

FIG. 4 shows logic 400 that illustrates that in some implementations, the device 200 may provide direction to the operator for ocular image data acquisition. For example, when the logic 400 determines to obtain ocular image data (402), the logic 400 may output directions on the display 102 to the operator. The instructions may prompt the operator to close one eye and press a key when ready (404), for example, so that the retinal image pattern of only one eye is present on the sensors 106.

The logic 400 may then wait for specified input (406) and optimally activate any of the illuminators 104 (408). The logic 400 then reads the sensor data from the sensors 106 (410). From the sensor data, the logic 300 may recognize, extract, or otherwise obtain ocular image data (412) for processing.

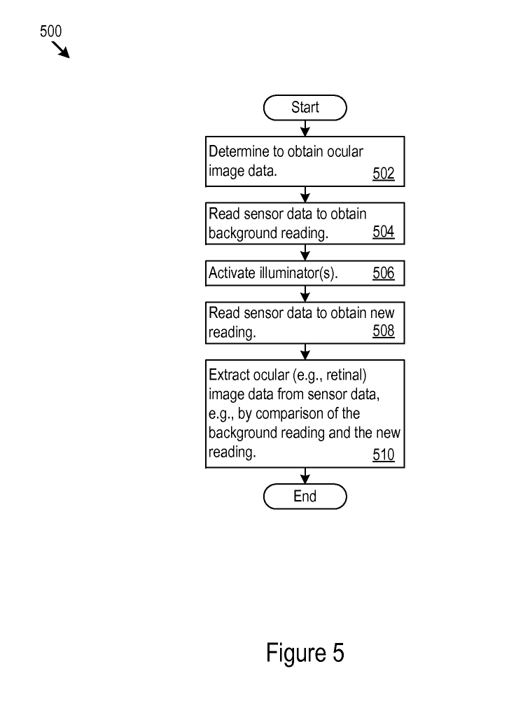

FIG. 5 shows logic 500 that illustrates that in some implementations, the device 200 may selectively control the illuminators 104 for obtaining ocular image data. For example, when the logic 500 determines to obtain ocular image data (502), the logic 500 may read sensor data to obtain a background reading (504). The logic 500 may then activate any of the illuminators 106 (506). For example, the activation may be a flash—an activation followed by a deactivation of the illuminators 106. The duration of the flash may be an acquisition parameter 218. Following the illumination, the logic 500 reads the sensor data again to obtain a new reading (508). Ocular image data is extracted from the sensor data (510). One technique for doing so includes comparing the background reading with the new reading. The difference between the background reading and the new reading may eliminate noise, and leave the ocular image data, which the illumination caused to more strongly appear in the new reading, due to the natural reflection of the illumination by the eye 112.

One beneficial aspect of the techniques described above is that the device 200 does not need a dedicated camera, light source, or external lenses to perform ocular imaging. Instead, the device uses the embedded light sensing area (e.g., the sensor plane 108) for a purpose that it was not originally or primarily intended for, i.e., for ocular imaging in addition to the primary purpose of, e.g., touch sensing. Devices that already include touch sensing (or that have light sensors for other reasons) may add retinal imaging, eye tracking, biometric identification, medical imaging and diagnosis, and other features with nearly zero additional hardware cost, using application software to perform whatever processing is desired.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method comprising:
reading sensor data from sensors associated with an electronic display;
recognizing that ocular image data is present in the sensor data; and
processing the ocular image data.

2. The method of claim 1, further comprising:
activating an illuminator prior to reading the sensor data.

3. The method of claim 2, where activating comprises:
activating a backlight associated with the electronic display prior to reading the sensor data.

4. The method of claim 2, where activating comprises:
activating an infra-red backlight prior to reading the sensor data.

5. The method of claim 2, where activating comprises:
activating a light emitting diode (LED) backlight prior to reading the sensor data.

6. The method of claim 1, where reading comprises:
reading the sensor data from photodiodes associated with the electronic display.

7. The method of claim 1, where reading comprises:
reading the sensor data from sensors of a touchscreen interface to the electronic display.

8. The method of claim 1, where processing the ocular image data comprises:
performing identity processing on retinal image data within the ocular image data.

9. The method of claim 1, where processing the ocular image data comprises:
performing location tracking using the ocular image data.

10. A device comprising:
a display controller operable to drive a display;
sensor inputs for sensors associated with the display; and
logic in communication with the sensor inputs, the logic operable to:
read sensor data from the sensor inputs;
obtain biometric data from the sensor data; and
process the biometric data.

11. The device of claim 10, where:
the sensor inputs comprise photodiode sensor inputs.

12. The device of claim 10, where:
the sensor inputs comprise touchscreen sensor inputs.

13. The device of claim 10, where:
the biometric data comprises ocular image data.

14. The device of claim 10, further comprising:
an illuminator control for activating an illuminator associated with the display prior to reading the sensor data.

15. The device of claim 14, where the illuminator control comprises:
an infra-red illuminator control.

16. The device of claim 14, where the illuminator control comprises:
a light emitting diode (LED) backlight control for a backlight for the display.

17. The device of claim 10, where the sensor inputs comprise:
sensor inputs from a sensor plane associated with the display.

18. The device of claim 10, where:
the logic is operable to process the biometric data by enhancing retinal image data within the biometric data.

19. The device of claim 18, where:
the logic is operable to enhance the retinal image data by subtracting background noise.

20. A device comprising:
a display;
a sensor plane associated with the display, the sensor plane operable to:
receive energy at the sensor plane focused by a lens of an eye viewing the display, instead of by an intermediate lens outside of the eye; and
logic in communication with the sensor plane, the logic operable to:
read sensor data arising from the energy received by the sensor plane; and
operate on ocular image data of the eye obtained from the sensor data.

21. The device of claim 20, where:
the sensor plane comprises a touchscreen sensor plane.

22. The device of the claim 20, where:
the energy comprises infra-red light.
